(19) United States
(12) Patent Application Publication
(10) Pub. No.: US 2006/0072345 A1
(43) Pub. Date: Apr. 6, 2006

(54) Backlight module and flat panel display employing the same

(75) Inventors: Ya-Ting Ho, Beigang Township (TW); Tsung-Hsun Hsieh, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/024,136

(22) Filed: Dec. 28, 2004

(30) Foreign Application Priority Data
Oct. 4, 2004 (TW) 93129977

(51) Int. Cl. F21V 7/04

(52) U.S. Cl. 362/633

(57) ABSTRACT

Flat panel display. A flat panel display comprises a first case, a second case connected to the first case, a light guide unit disposed between the first and second cases, a flat display panel and a light assembly. The light guide unit includes a light incident surface. The flat display panel includes a display surface between the first case and the light guide unit. A recess, formed by the light incident surface and the first and second cases, includes an opening toward a direction substantially parallel to the display surface. The light assembly is fixed in the recess, comprising a third case and a light source disposed in the third case.

### BACKGROUND

The invention relates in general to flat panel displays and in particular to flat panel displays with detachable backlight modules.

A flat panel display, such as a liquid crystal display (LCD), typically comprises a backlight module emitting light for illuminating a display panel. Conventional direct and side-edge type backlight modules, comprising fluorescent lamps, have been employed in flat panel displays. Cold cathode fluorescent lamps (CCFLs) or external electrode fluorescent lamps (EEFLs) are typically utilized.

Referring to FIG. 1, as disclosed in U.S. Pat. No. 5,537,296, a backlight for a liquid crystal display comprises a lamp holding unit 24 connected to a lamp guard unit 26, thereby joining the backlight 20 to a side of a light-guide plate 22. The lamp guard unit 26 includes a top holder 38 comprising resin, a top reflective film 42 bonded to the top holder 38, and a fluorescent tube 44 accommodated in the top holder 38. The lamp holding unit 24 includes a bottom holder 28 and a bottom reflective film 36 bonded thereto.

More specifically, the lamp guarding unit 26 of the backlight 20 is detachable from a lamp holding unit 24 fixed to the light-guide plate 22 in a direction perpendicular to a light illumination surface of the light-guide plate 22. Although the top holder 38 comprises resin in U.S. Pat. No. 5,537,296, this may adversely hinder heat dissipation of the fluorescent tube 44. Moreover, a mechanism of this type is complicated and may potentially increase the difficulty and cost of assembly.

### SUMMARY

Backlight modules and flat panel displays employing the same are provided. An exemplary embodiment of a flat panel display comprises a first case, a second case connected to the first case, a light guide unit disposed between the first and second cases, a flat display panel and a light assembly. The light guide unit comprises a light incident surface. The flat display panel comprises a display surface between the first case and the light guide unit. A recess, formed by the light incident surface and the first and second cases, comprises an opening toward a direction substantially parallel to the display surface. The light assembly is fixed in the recess, comprising a third case and a light source disposed in the third case.

An exemplary embodiment of a backlight module comprises a first case, a second case connected to the first case, a light guide unit disposed between the first and second cases and a light assembly. The light guide unit comprises a light incident surface and an illumination surface. A recess, formed by the light incident surface and the first and second cases, comprises an opening toward a direction substantially parallel to the illumination surface. The light assembly is fixed in the recess, comprising a third case and a light source disposed in the third case.

### DESCRIPTION, OF THE DRAWINGS

FIG. 1 is an exploded diagram of a conventional backlight module;

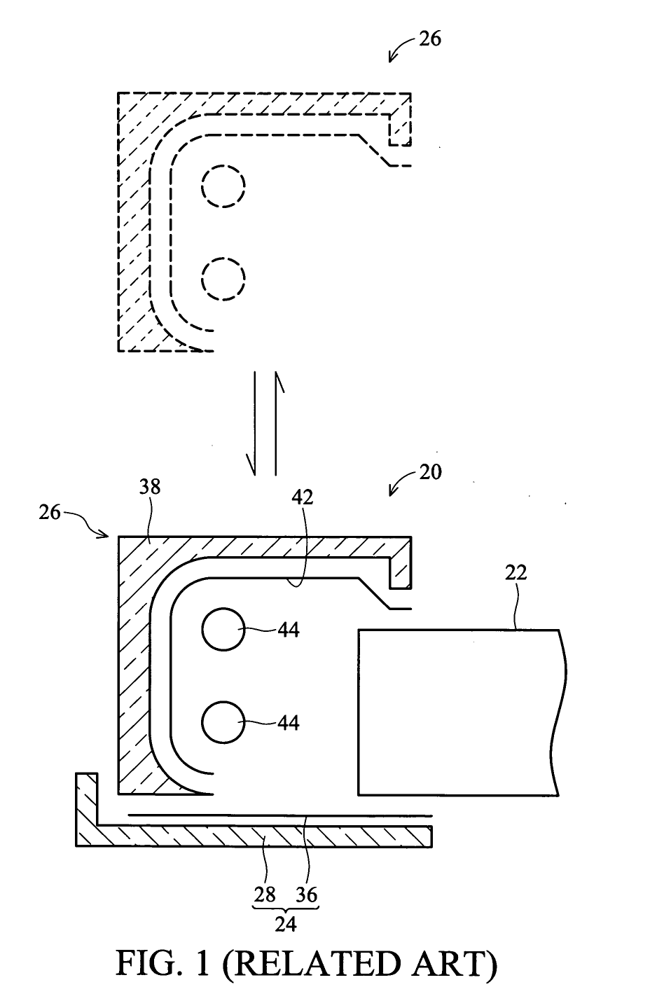

FIG. 2a is a perspective diagram of a light assembly joined to a main body of a flat panel display according to an embodiment of the present invention;

FIG. 2b is a sectional view of IIA-IIA′ in FIG. 2a;

FIG. 2c is a perspective diagram of an embodiment of a light assembly joined to a main body of a flat panel display by a screw;

FIG. 3 is a perspective diagram of the flat panel display after assembly with respect to FIG. 2a; and

FIG. 4 is a sectional view of IIIA-IIIA′ in FIG. 3.

### DETAILED DESCRIPTION

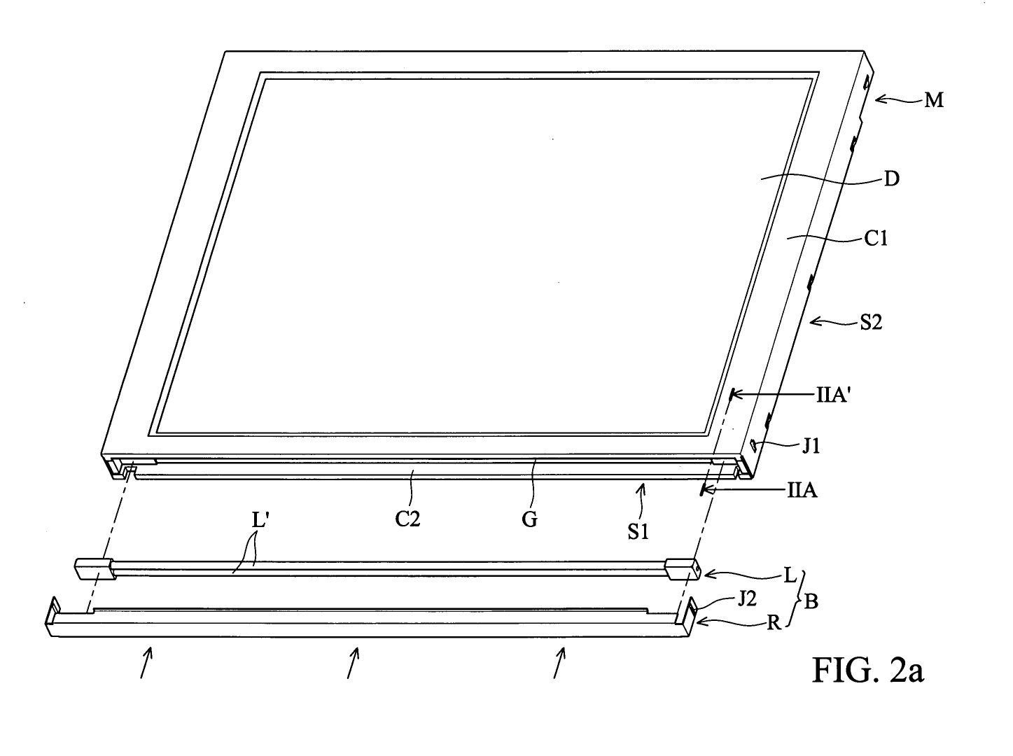

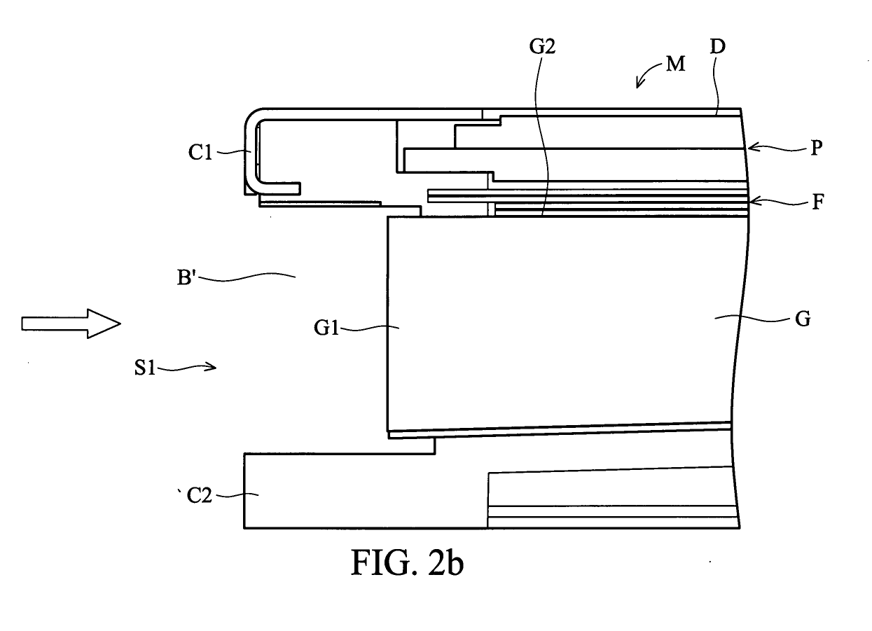

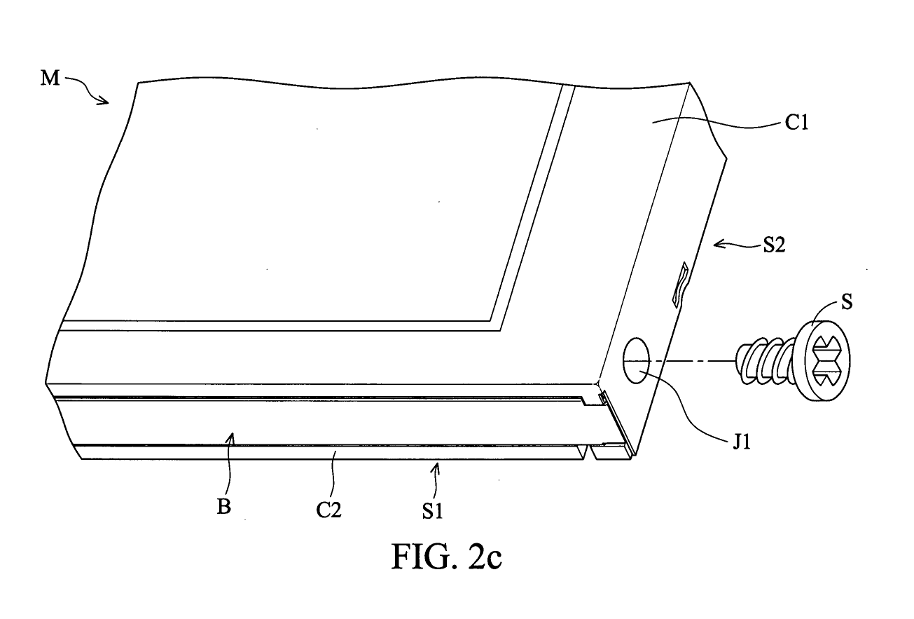

Backlight modules and flat panel displays employing the same are provided. Referring to FIG. 2a, an exemplary embodiment of a flat panel display, such as a liquid crystal display, primarily comprises a main body M and a light assembly B. The main body M comprises a first case C1, a second case C2 and a light guide unit G disposed therebetween. In some embodiments, the first case C1 comprises metal, and the second case C2 comprises plastic.

The light assembly B includes a light source L and a metallic third case R partially enclosing the light source L. As shown in FIG. 2a, the light source L comprises at least a fluorescent element L′, such as a Cold Cathode Fluorescent Lamp (CCFL) or an External Electrode Fluorescent Lamp (EEFL). The light assembly B is joined to a first side S1 of the main body M as a backlight module, thus illuminating a display surface D of a display panel disposed at the center of the main body M.

In FIG. 2a, the main body M has a first connection portion J1 disposed on a second side S2 thereof. In some embodiments, the connection portion J1 can be alternatively disposed on the first case C1 or the second case C2. The light assembly B is inserted into the main body M from the first side S1 with the connection portion J1 joined to a second connection portion J2 of the third case R, thereby connecting the light assembly B and the main body M. As shown in FIG. 2a, the connection portion J1 is a slot, and correspondingly, the second connection portion J2 is a protrusion joined in the slot. In some embodiments, as shown in FIG. 2c, the connection portion J1 may be a threaded hole with a screw S fastened therethrough for fixing the light assembly B to the first side S1 of the main body M.

Referring to FIGS. 2a and 2b, wherein FIG. 2b is a sectional view of IIA-IIA′ in FIG. 2a. In FIG. 2b, the light guide unit G is disposed between the first case C1 and the second case C2, comprising a light incident surface G1 and an illumination surface G2. More specifically, a recess B′ is formed by the light incident surface G1, the first case C1 and the second case C2, having an opening toward a direction substantially parallel to the illumination surface G2 of the light guide unit G.

During assembly of the flat panel display, as shown by the arrows in FIGS. 2a and 2b, the light assembly B is inserted into the recess B′ from the first side S1 of the main body M. As mentioned, the light assembly B and the main body M are connected by joining the first and second connection portions J1 and J2.

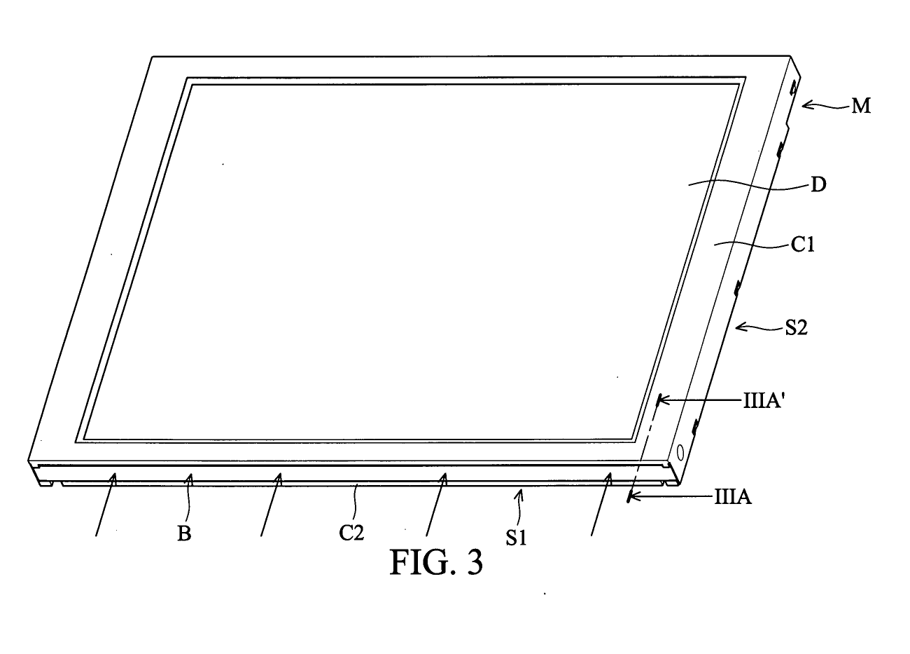

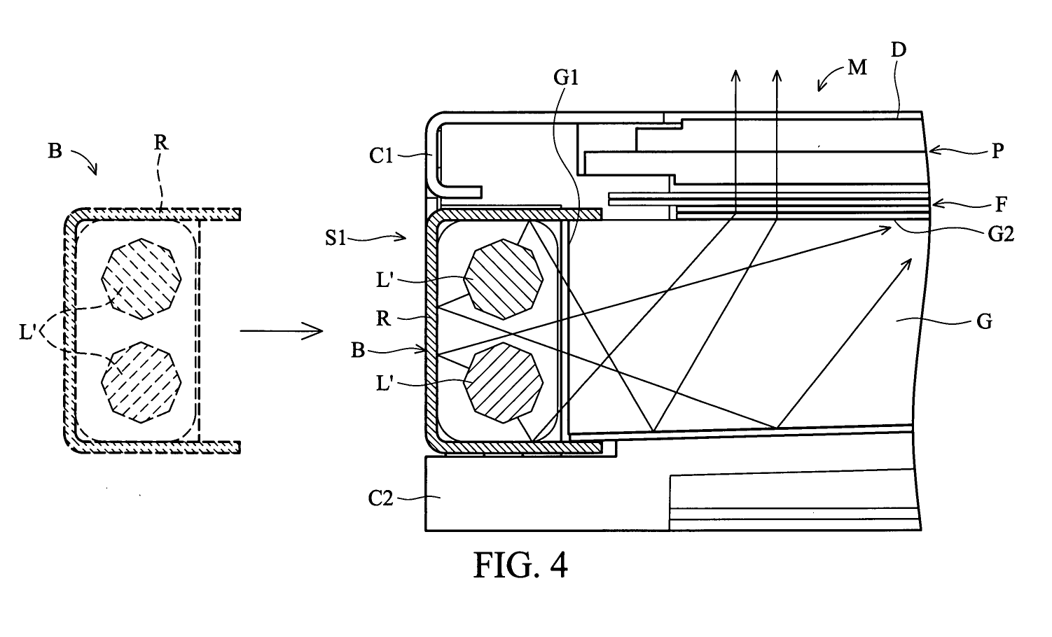

Referring to FIGS. 3 and 4, wherein FIG. 4 is a sectional view of IIIA-IIIA′ in FIG. 3. As shown by the arrow in FIG. 4, the light assembly B is inserted into the recess B′ through an opening thereof along the direction substantially parallel to the illumination surface G2 of the light guide unit G, thus fixing the light assembly B to the first side S1 of the main body M. In FIG. 4, the third case R is U-shaped partially enclosing the fluorescent element L′, and an opening of the third case R is opposite the recess B′ for assembly. Thus, the light assembly B can be correctly and easily connected to the first side S1 as shown in FIG. 4. With reflective material on the inner surface of the third case R, light from the fluorescent element L′ can be reflected and guided into the light guide unit G.

In FIG. 4, light from the fluorescent element L′ progresses in the light guide unit G and exits upward via the illumination surface G2 thereof. Subsequently, light passes through some optical films F and a flat display panel P of the flat panel display disposed between the first case C1 and the light guide unit G. As shown in FIG. 4, the display surface D of flat display panel P is parallel to the illumination surface G2 of the light guide unit G.

As the light assembly B is detachably joined in the recess B′ at a side of the flat panel display by insertion along a direction substantially parallel to the display surface D, it can potentially simplify the assembly and reduce fabrication cost. Furthermore, as the third case R comprises metal rather than resin, it can potentially facilitate heat dissipation and may extend lifetime of the fluorescent lamps.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A backlight module, comprising:
a first case;
a second case connected to the first case;
a light guide unit, disposed between the first and second cases, having a light incident surface and an illumination surface;
a recess, formed by the light incident surface, and the first and second cases, having an opening toward a direction substantially parallel to the illumination surface; and
a light assembly, fixed in the recess, including a third case and a light source disposed in the third case.

2. The backlight module as claimed in claim 1, wherein the first case comprises a first connection portion, and the third case comprises a second connection portion joined to the first connection portion, thereby fixing the light assembly in the recess.

3. The backlight module as claimed in claim 2, wherein the first connection portion comprises a slot and the second connection portion comprises a protrusion joined in the slot.

4. The backlight module as claimed in claim 1, wherein the first case comprises a threaded hole with a screw fastened therethrough, thereby fixing the light assembly in the recess.

5. The backlight module as claimed in claim 1, wherein the third case is U-shaped partially enclosing the light source.

6. The backlight module as claimed in claim 1, wherein the third case comprises metal.

7. The backlight module as claimed in claim 1, wherein the first case comprises metal.

8. The backlight module as claimed in claim 1, wherein the second case comprises plastic.

9. The backlight module as claimed in claim 1, wherein the light source comprises a cold cathode fluorescent lamp (CCFL).

10. The backlight module as claimed in claim 1, wherein the light source comprises an external electrode fluorescent lamp (EEFL).

11. A flat panel display, comprising:
a first case;
a second case connected to the first case;
a light guide unit, disposed between the first and second cases, having a light incident surface;
a flat display panel, disposed between the first case and the light guide unit, having a display surface;
a recess, formed by the light incident surface and the first and second cases, having an opening toward a direction substantially parallel to the display surface; and
a light assembly, fixed in the recess, including a third case and a light source disposed in the third case.

12. The flat panel display as claimed in claim 11, wherein the first case comprises a first connection portion, and the third case comprises a second connection portion joined to the first connection portion, thereby fixing the light assembly in the recess.

13. The flat panel display as claimed in claim 12, wherein the first connection portion comprises a slot and the second connection portion comprises a protrusion joined in the slot.

14. The flat panel display as claimed in claim 11, wherein the first case comprises a threaded hole with a screw fastened therethrough, thereby fixing the light assembly in the recess.

15. The flat panel display as claimed in claim 11, wherein the third case is U-shaped partially enclosing the light source.

16. The flat panel display as claimed in claim 11, wherein the third case comprises metal.

17. The flat panel display as claimed in claim 11, wherein the first case comprises metal.

18. The flat panel display as claimed in claim 11, wherein the second case comprises plastic.

19. The flat panel display as claimed in claim 11, wherein the light source comprises a cold cathode fluorescent lamp (CCFL).

20. The flat panel display as claimed in claim 11, wherein the light source comprises an external electrode fluorescent lamp (EEFL).
